(19) United States
(12) Patent Application Publication
(10) Pub. No.: US 2026/0129571 A1
(43) Pub. Date: May 7, 2026

(54) CAPACITY BOOSTER CELL AND CONTROL METHOD THEREOF

(71) Applicant: INSTITUTE FOR INFORMATION INDUSTRY, TAIPEI (TW)

(72) Inventors: Hsien Tsung HSU, TAIPEI (TW); Ping CHANG, TAIPEI (TW); Wen Yao CHANG, TAIPEI (TW)

(21) Appl. No.: 18/964,706

(22) Filed: Dec. 2, 2024

(30) Foreign Application Priority Data
Nov. 4, 2024 (TW) 113142172

(51) Int. Cl. H04W 52/02; H04W 36/34

(52) U.S. Cl. CPC H04W 52/0203; H04W 36/34

(57) ABSTRACT

A capacity booster cell and control method thereof are provided. The capacity booster cell provides a communication service for at least one terminal apparatus based on an active mode, an energy saving transition mode, and an energy saving mode. In the active mode, the capacity booster cell determines whether to switch to the energy saving transition mode based on a predicted load information. In the energy saving transition mode, the capacity booster cell hands over the communication service of the at least one terminal apparatus to at least one neighbor cell. In response to completing handing over the communication service of the at least one terminal apparatus, the capacity booster cell is switched to the energy saving mode, wherein the capacity booster cell in the energy saving mode is suspended from providing the communication service.

### CROSS-REFERENCE TO RELATED APPLICATION

This application claims priority to Taiwan Application Serial Number 113142172, filed November 4, 2024, which is herein incorporated by reference in its entirety.

### BACKGROUND

### Field of Invention

The present disclosure relates to a capacity booster cell and control method thereof. More particularly, the present disclosure relates to an energy efficient capacity booster cell and control method thereof.

### Description of Related Art

With the development of communication technology, mobile communication technology has been applied to many services. Therefore, telecom operators have supported more frequency bands, larger bandwidth, more antennas, and denser networks to cope with market demand.

According to research, the energy consumed by mobile communication networks is mainly to maintain wireless networks, and the energy consumption of base stations accounts for the largest proportion. Therefore, base station energy saving has always been a research focus in the field of mobile communication network energy saving.

In the standards set by 3GPP, the capacity booster cell (CBC) can hand over the connected user equipment (UE) to other base stations and switch to energy saving mode in order to reduce energy consumption when the load is decreased. On the other hand, coverage cells (CC) are used to provide wider signal coverage. When the load of the coverage cell increases, the communication services of some user equipment can be handed over to the capacity booster cell within the coverage area for load distribution.

However, in the existing energy saving mode switching mechanism, there are the following problems: (1) when the capacity booster cell hands over its own traffic to other base stations and switches to the energy saving mode, causing other base stations to be overloaded, the capacity booster cell still has to be reactivated to share overloaded traffic, causing the capacity booster cell to switch on and off repeatedly; (2) when two adjacent capacity booster cells hand over user equipment to each other at the same time for entering into energy saving mode, neither of them is able to clear the load and switch to energy saving mode.

In view of this, how to avoid the above conflict situation and enable the capacity booster cell to switch to an energy saving mode is the goal that the industry strives to work on.

### SUMMARY

The disclosure provides a capacity booster cell comprising a communication interface and a processor. The communication interface is communicatively connected to a coverage cell. The processor is electrically connected to the communication interface. The capacity booster cell provides a communication service for at least one terminal apparatus via the communication interface based on an active mode, an energy saving transition mode, and an energy saving mode. In response to the capacity booster cell being switched to the active mode, the processor executing the following operation: determining whether to switch the capacity booster cell to the energy saving transition mode based on a predicted load information corresponding to the capacity booster cell. In response to the capacity booster cell being switched to the energy saving transition mode, the processor executing the following operations: handing over the communication service corresponding to the at least one terminal apparatus to at least one neighboring cell, wherein the at least one neighboring cell comprises the coverage cell or a neighboring capacity booster cell corresponding to the capacity booster cell; and in response to completing handing over the communication service of the at least one terminal apparatus, switching the capacity booster cell to the energy saving mode, wherein the capacity booster cell in the energy saving mode is suspended from providing the communication service.

The disclosure further provides a capacity booster cell comprising a communication interface and a processor. The communication interface is communicatively connected to a coverage cell. The processor is electrically connected to the communication interface. The capacity booster cell provides a communication service for at least one terminal apparatus via the communication interface based on an energy saving mode, an active transition mode, and an active mode. In response to the capacity booster cell being switched to the energy saving mode, the processor executing the following operations: suspending the communication service; and determining whether to switch the capacity booster cell to the active transition mode based on a predicted load information corresponding to the coverage cell. In response to the capacity booster cell being switched to the active transition mode, the processor executing the following operations: transmitting a handover invitation to the coverage cell; receiving a handover request corresponding to the handover invitation from the coverage cell, wherein the handover request corresponding to the at least one terminal apparatus; and determining whether to switch the capacity booster cell to the active mode based on the handover request to provide the communication service for the at least one terminal apparatus.

The disclosure further provides a control method being adapted for use in a capacity booster cell. The control method provides a communication service for at least one terminal apparatus via the capacity booster cell based on an active mode, an energy saving transition mode, and an energy saving mode. In response to the capacity booster cell being switched to the active mode, the control method comprises the following step: determining whether to switch the capacity booster cell to the energy saving transition mode based on a predicted load information corresponding to the capacity booster cell. In response to the capacity booster cell being switched to the energy saving transition mode, the control method comprises the following steps: handing over the communication service corresponding to the at least one terminal apparatus to at least one neighboring cell, wherein the at least one neighboring cell comprises a coverage cell or a neighboring capacity booster cell corresponding to the capacity booster cell; and in response to completing handing over the communication service of the at least one terminal apparatus, switching the capacity booster cell to the energy saving mode, wherein the capacity booster cell in the energy saving mode is suspended from providing the communication service.

The disclosure further provides a control method being adapted for use in a capacity booster cell. The control method provides a communication service for at least one terminal apparatus via the capacity booster cell based on an energy saving mode, an active transition mode, and an active mode. In response to the capacity booster cell being switched to the energy saving mode, the control method comprises the following steps: suspending the communication service; and determining whether to switch the capacity booster cell to the active transition mode based on a predicted load information corresponding to a coverage cell. In response to the capacity booster cell being switched to the active transition mode, the control method comprises the following steps: transmitting a handover invitation to the coverage cell; receiving a handover request corresponding to the handover invitation from the coverage cell, wherein the handover request corresponding to the at least one terminal apparatus; and determining whether to switch the capacity booster cell to the active mode based on the handover request to provide the communication service for the at least one terminal apparatus.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating coverage cells and capacity booster cells according to some embodiments of the present disclosure.

FIG. 2 is a schematic diagram illustrating a capacity booster cell according to an embodiment of the present disclosure.

FIG. 3 is a schematic diagram illustrating mode switching of the capacity booster cell according to an embodiment of the present disclosure.

FIG. 4A is a schematic diagram illustrating the capacity booster cell switching from the active mode to the energy saving mode according to an embodiment of the present disclosure.

FIG. 4B is a schematic diagram illustrating a neighboring cell operating corresponding to FIG. 4A according to an embodiment of the present disclosure.

FIG. 4C is a schematic diagram illustrating the capacity booster cell switching from the active mode to the energy saving mode according to another embodiment of the present disclosure.

FIG. 5A is a schematic diagram illustrating the capacity booster cell switching from the energy saving mode to the active mode according to an embodiment of the present disclosure.

FIG. 5B is a schematic diagram illustrating the coverage cell operating corresponding to FIG. 5A according to an embodiment of the present disclosure.

FIG. 6 is a flow diagram illustrating a base station control method switching from an active mode to an energy saving mode according to another embodiment of the present disclosure.

FIG. 7 is a flow diagram illustrating a base station control method switching from the energy saving mode to the active mode method according to another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

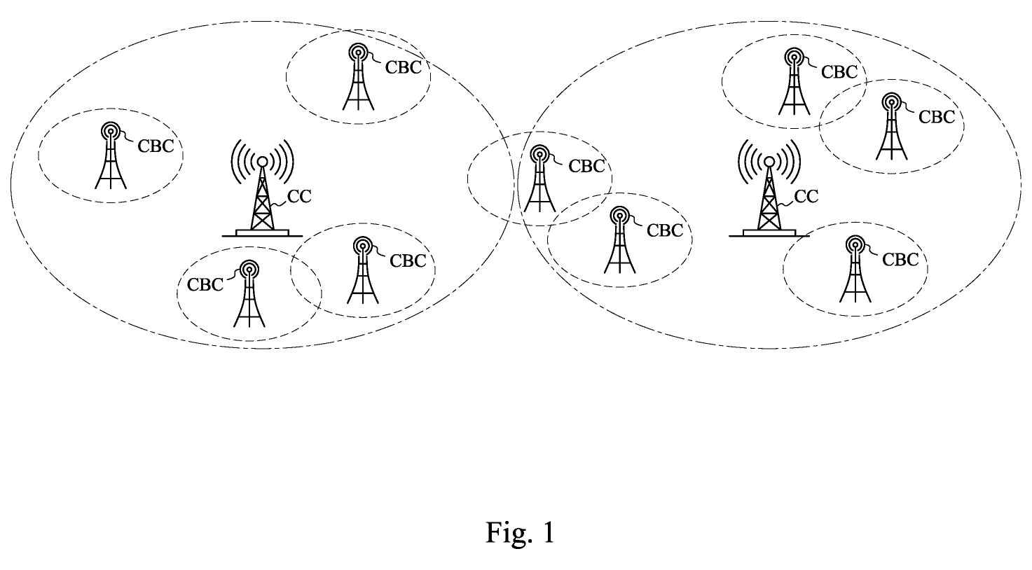

First, please refer to FIG. 1, which is a schematic diagram illustrating coverage cells CC and capacity booster cells CBC according to some embodiments of the present disclosure. As the area framed by the dash-dotted line, the coverage cells CC have a larger signal coverage area. Relatively, as the area framed by the dashed line, the capacity booster cells CBC are configured to share part of the signal load. The coverage cells CC and the capacity booster cells CBC are configured to provide a communication service for terminal apparatuses (i.e., user equipment) within the signal coverage area.

When the number of user equipment within the signal coverage area of a capacity booster cell CBC reduces, and the capacity booster cell CBC is ready to switch to the energy saving mode, the capacity booster cell CBC can hand over the communication service it provides for the user equipment to the neighboring coverage cell CC or the neighboring capacity booster cell CBC, e.g., the coverage cell CC or the capacity booster cell CBC with overlapping signal coverage areas.

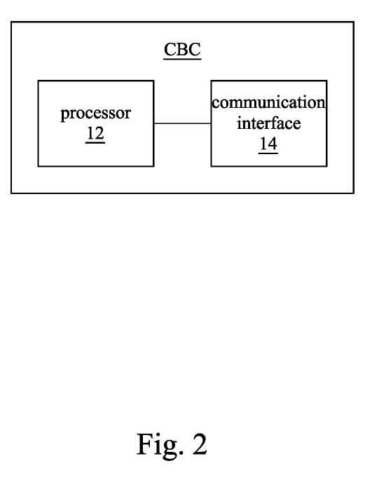

Please refer to FIG. 2, which is a schematic diagram illustrating a capacity booster cell CBC according to an embodiment of the present disclosure. The capacity booster cell CBC includes a processor 12 and a communication interface 14, wherein the processor 12 is electrically connected to the communication interface 14.

In some embodiments, the processor 12 includes a central processing unit (CPU), a graphics processing unit (GPU), a multi-processor, a distributed processing system, an application specific integrated circuit (ASIC), and/or a suitable processing unit.

The communication interface 14 is communicatively connected to the coverage cell CC, e.g., the capacity booster cell CBC in the signal coverage area of a coverage cell CC connects to the coverage cell CC. In some embodiments, the communication interface 14 is also communicatively connected to other neighboring capacity booster cells CBC. Additionally, the communication interface 14 is also configured to communicatively connect to one or more terminal apparatus (e.g., user equipment) to provide the communication service.

In some embodiments, the communication interface 14 is communicatively connected to the coverage cell CC, the capacity booster cell CBC, and the terminal apparatus respectively based on different communication protocols, e.g., connecting via different frequency bands or connecting via wired or wireless connection.

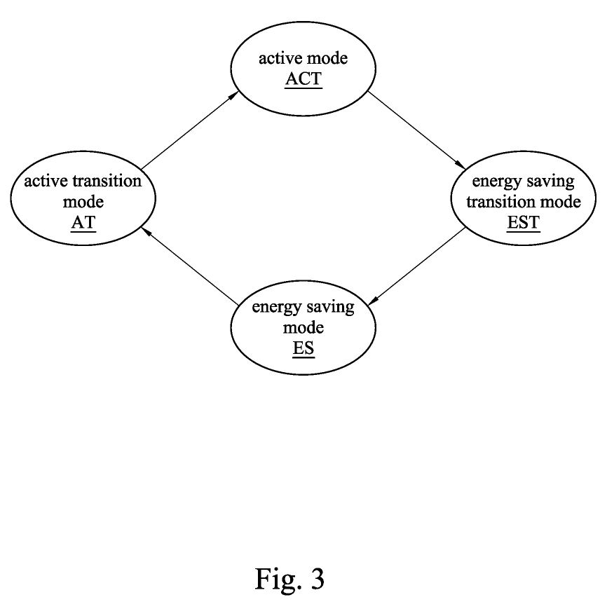

Please refer to FIG. 3, which is a schematic diagram illustrating mode switching of the capacity booster cell CBC according to an embodiment of the present disclosure. When the load of the capacity booster cell CBC reduces to a certain level, and the capacity booster cell CBC has to switch from the active mode to the energy saving mode, the capacity booster cell CBC is configured to provide the communication service for at least one terminal apparatus via the communication interface 14 based on an active mode ACT, an energy saving transition mode EST, and an energy saving mode ES.

Relatively, when the load demand rises, and the capacity booster cell CBC needs to switch from the energy saving mode to the active mode, the capacity booster cell CBC provides a communication service for at least one terminal apparatus via the communication interface 14 based on an energy saving mode ES, an active transition mode AT, and an active mode ACT.

About the details of the mode switching, please refer to FIG. 3. As shown in the figure, before switching from the active mode ACT to the energy saving mode ES, the capacity booster cell CBC in the present disclosure switches to the energy saving transition mode EST first. Furthermore, after confirming that the terminal apparatus being served has been handed over, the capacity booster cell CBC then switches to the energy saving mode ES.

Specifically, in response to the capacity booster cell CBC being switched to the active mode ACT, the processor 12 executes the following operation: determining whether to switch the capacity booster cell CBC to the energy saving transition mode EST based on a predicted load information corresponding to the capacity booster cell CBC. In response to the capacity booster cell CBC being switched to the energy saving transition mode EST, the processor 12 executes the following operations: handing over the communication service corresponding to the at least one terminal apparatus to at least one neighboring cell, wherein the at least one neighboring cell includes the coverage cell CC or a neighboring capacity booster cell corresponding to the capacity booster cell CBC; and in response to completing handing over the communication service of the at least one terminal apparatus, switching the capacity booster cell CBC to the energy saving mode ES, wherein the capacity booster cell CBC in the energy saving mode ES is suspended from providing the communication service.

For example, while being in the active mode ACT, the capacity booster cell CBC provides communication service for the terminal apparatus within its signal coverage area and predicts the load traffic of the future simultaneously. When the predicted future traffic meets a specific condition (e.g., the traffic being lower than a threshold), the capacity booster cell CBC switches to the energy saving transition mode EST.

After switching to the energy saving transition mode EST, the capacity booster cell CBC hands over the communication service for the user equipment to the neighboring coverage cell CC and/or the neighboring capacity booster cell CBC (i.e., the neighboring cells). Next, after handing over the communication service for all of the connected terminal apparatus, the capacity booster cell CBC switches to the energy saving mode ES.

Relatively, before switching from the energy saving mode ES to the active mode ACT, the capacity booster cell CBC in the present disclosure switches to the active transition mode AT first. Furthermore, after confirming the load of terminal apparatuses needed to be taken over, the capacity booster cell CBC then switches to the active mode ACT.

Specifically, in response to the capacity booster cell CBC being switched to the energy saving mode ES, the processor 12 executing the following operations: suspending the communication service; and determining whether to switch the capacity booster cell CBC to the active transition mode AT based on a predicted load information corresponding to the coverage cell CC. In response to the capacity booster cell CBC being switched to the active transition mode AT, the processor 12 executing the following operations: transmitting a handover invitation to the coverage cell CC; receiving a handover request corresponding to the handover invitation from the coverage cell CC, wherein the handover request corresponding to the at least one terminal apparatus; and determining whether to switch the capacity booster cell CBC to the active mode ACT based on the handover request to provide the communication service for the at least one terminal apparatus.

For example, while being in the energy saving mode ES, the capacity booster cell CBC suspends the communication service and predicts the load traffic of the coverage cell CC at a future time point simultaneously (e.g., the capacity booster cell CBC within the signal coverage area of a coverage cell CC predicting the future traffic of the coverage cell CC). When the predicted future traffic meets a specific condition (e.g., the traffic being greater than a threshold), the capacity booster cell CBC switches to the active transition mode AT.

After switching to the active transition mode AT, the capacity booster cell CBC transmits a handover invitation to the coverage cell CC to confirm how many terminal apparatuses are there whose communication service may be handed over to the capacity booster cell CBC. Correspondingly, the coverage cell CC transmits a handover request after receiving the handover invitation. After receiving the handover request, the capacity booster cell CBC can obtain the number of terminal apparatuses and/or the load traffic to be handed over and determine whether to switch to the active mode ACT in order to share the load of the coverage cell CC. Finally, if switching to the active mode ACT, the capacity booster cell CBC will take over the communication service of the terminal apparatus from the coverage cell CC.

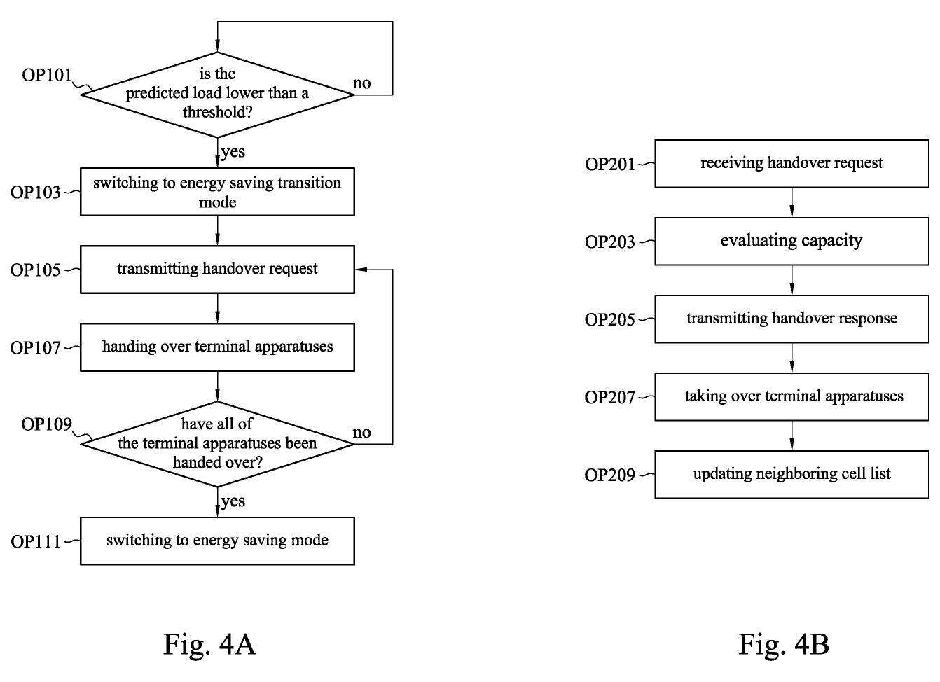

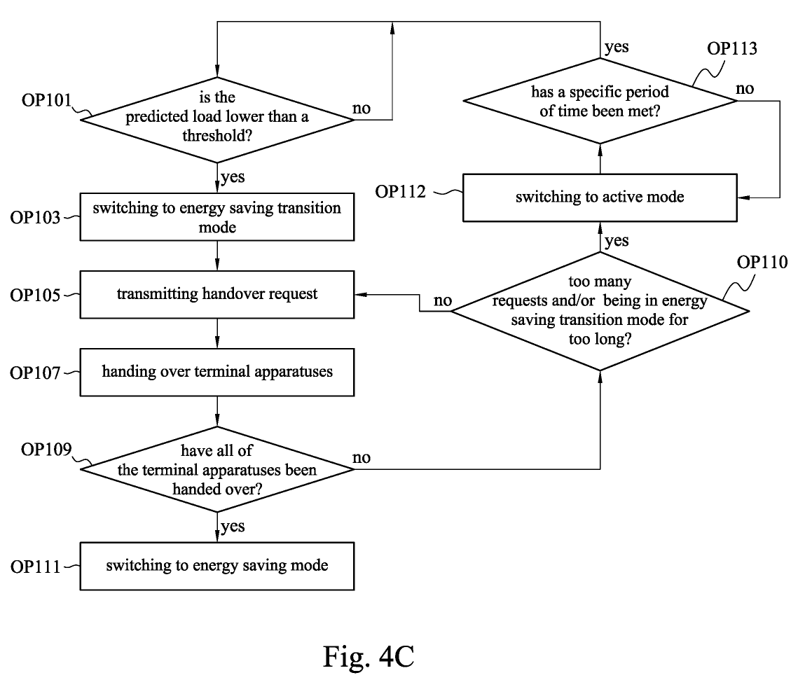

Please further refer to FIG. 4A, which is a schematic diagram illustrating the capacity booster cell CBC switching from the active mode ACT to the energy saving mode ES according to an embodiment of the present disclosure. On the other hand, please also refer to FIG. 4B, which is a schematic diagram illustrating a neighboring cell operating corresponding to FIG. 4A according to an embodiment of the present disclosure.

First, in operation OP101, the capacity booster cell CBC determines whether the predicted load of the future is lower than a threshold.

In some embodiments, while being switched to the active mode ACT, the capacity booster cell CBC calculates the predicted load of the future by using a machine learning model based on the past and current load data (i.e., past load record). The load data includes information such as frequency bands being distributed and used, the physical resource blocks (PRB), the number of connected apparatuses, the upstream traffic, the downstream traffic, etc.

Specifically, the operation of determining whether to switch the capacity booster cell CBC to the energy saving transition mode EST further includes: calculating the predicted load information of the capacity booster cell CBC based on a past load record of the capacity booster cell CBC; and in response to the predicted load information being lower than a first load threshold, determining to switch the capacity booster cell CBC to the energy saving transition mode EST.

It is noted that, the machine learning model used for calculating the predicted load is generated after trained and/or fine-tuned by using the past load data based on a model structure such as Long Short-Term Memory (LSTM), Transformer, Gated Recurrent Unit (GRU), etc., but the present disclosure is not limited thereto.

It is noted that, the first load threshold may be generated by calculating the past load record of the capacity booster cell CBC. In some embodiments, the capacity booster cell CBC calculates the average value of multiple load traffic values of itself in the past period of time as the first load threshold.

In some embodiments, the machine learning model calculates the predicted traffic in the future period of time, and the capacity booster cell CBC determines whether the predicted traffic is lower than the first load threshold to decide whether to switch the mode.

As mentioned above, if the predicted load is not lower than the first load threshold, the capacity booster cell CBC stays in the active mode ACT and continues to calculate the predicted load; relatively, if the predicted load is lower than the first load threshold, the capacity booster cell CBC executes operation OP103, switching to the energy saving transition mode EST.

In some embodiments, after determining the predicted load being lower than the first load threshold, the capacity booster cell CBC also confirms the current and future load information to determine whether to switch to the energy saving transition mode EST.

Specifically, in response to determining to switch the capacity booster cell CBC to the energy saving transition mode EST, the processor 12 executes the following operations: obtaining at least one neighboring load information from at least one neighboring cell; and determining whether to cancel switching to the energy saving transition mode EST based on the at least one neighboring load information.

For example, when the predicted load is lower than the first load threshold, the capacity booster cell CBC transmits a resource status request to the neighboring cell, and the neighboring cell replies with a resource status response after receiving the resource status request, wherein the resource status response includes the current and future load information of the neighboring cell. If the future load traffic is too high, and the capacity booster cell CBC may then have to share the traffic, the capacity booster cell CBC cancels switching to the energy saving transition mode EST.

In some embodiments, while switching to the energy saving transition mode EST, the capacity booster cell CBC further broadcasts a signal to the surrounding terminal apparatus to reject connection and transmits signals to the surrounding base stations to reject taking over the communication service of terminal apparatuses. In the meantime, if receiving a handover request, the capacity booster cell CBC responds with a cancel handover signal to reject the handover request. On the other hand, for the handover request previously confirmed but has not been handed over accordingly, the capacity booster cell CBC also transmits a cancel handover signal to cancel the handover operation.

Specifically, in response to determining to switch the capacity booster cell CBC to the energy saving transition mode EST, the processor 12 executes the following operations: broadcasting a first barring signal to at least one neighboring terminal apparatus to suspend the communication service for the at least one neighboring terminal apparatus; transmitting a second barring signal to the at least one neighboring cell to reject a handover request corresponding to the at least one neighboring cell; and in response to receiving the handover request from the at least one neighboring cell, returning a cancel handover signal to the at least one neighboring cell; and after broadcasting the first barring signal and transmitting the second barring signal, switching the capacity booster cell CBC to the energy saving transition mode EST.

For example, the capacity booster cell CBC broadcasts cellBarred signal via Master Information Block (MIB) to reject terminal apparatuses intending to connect to it. The capacity booster cell CBC notifies the neighboring cells of its preparation to enter into the energy saving transition mode EST via Xn interface in order to avoid the neighboring cells from making handover requests.

As to the handover request has been confirmed with a handover request acknowledgement (HO REQ ACK) but has not been handed over accordingly, the capacity booster cell CBC transmits a handover cancel request (HO cancel REQ) to the corresponding neighboring cell to suspend the handover. After that, if the neighboring cell refuses to cancel the handover (e.g., receiving a reject cancelling signal from the neighboring cell), the capacity booster cell CBC will still switch to the energy saving transition mode EST after completing the handover, and then handing over the communication service of the terminal apparatus to other base stations in the subsequent operations.

After switching to the energy saving transition mode EST, the capacity booster cell CBC executes operation OP105, transmitting an energy saving handover request (ES HO REQ) to the neighboring cell to confirm if the communication service of the terminal apparatus is able to be handed over, wherein the handover request includes the quantity and traffic of the terminal apparatuses to be handed over.

In some embodiments, the capacity booster cell CBC predicts the future trajectories of the terminal apparatuses by using a machine learning model based on the past and current locations of each of the terminal apparatuses. Furthermore, the capacity booster cell CBC distributes the terminal apparatuses to the neighboring cells based on the future trajectories, e.g., distributing to the nearest base station.

Specifically, the operation of handing over the communication service corresponding to the at least one terminal apparatus further includes: distributing the at least one terminal apparatus to the at least one neighboring cell respectively based on at least one trajectory prediction corresponding to the at least one terminal apparatus to generate a distribution result; transmitting at least one handover request to the at least one neighboring cell based on the distribution result; receiving a handover response corresponding to the at least one handover request from the at least one neighboring cell; and handing over the communication service of at least one of the at least one terminal apparatus based on the handover response.

Similarly, the machine learning model used for predicting the terminal apparatus trajectories is generated after trained and/or fine-tuned by using the past location record of the terminal apparatuses.

In some embodiments, after distributing the terminal apparatuses to each neighboring cells, the handover request transmitted by the capacity booster cell CBC also includes the quantity, traffic, and predicted trajectories of terminal apparatuses to be handed over to the specific neighboring cells.

Please return to FIG. 4B, after the capacity booster cell CBC transmits the handover request, in operation OP201, the neighboring cell receives the handover request.

Furthermore, in the operation OP203, the neighboring cell evaluates the capacity of itself based on the handover request and determines the quantity and/or traffic of the terminal apparatus able to be taken over.

Next, in operation OP205, the neighboring cell transmits the handover response to the capacity booster cell CBC based on the evaluation result.

For example, suppose the handover request transmitted by the capacity booster cell CBC indicates that there are 7 terminal apparatuses to be handed over, 3 of them have been distributed to the neighboring cell A, and the handover request also records the predicted trajectory, service requirements (e.g., frequency band, QoS), resource requirement, and/or traffic of each of the terminal apparatuses.

In the meantime, if the capacity of the neighboring cell cannot accommodate any more terminal apparatuses, the neighboring cell responds with an energy saving handover failure signal (ES HO Failure).

In another case, if the neighboring cell is able to take over terminal apparatuses, the neighboring cell responds with an energy saving handover request acknowledgement (ES HO REQ ACK), wherein the acknowledgement includes the quantity of the terminal apparatuses, the traffic of the terminal apparatuses, the preserved frequency band resource, and/or the preserved computation resource.

It is noticed that, if the quantity and/or traffic of the terminal apparatuses able to be taken over by the neighboring cell is greater than the quantity and/or traffic of the terminal apparatuses have been distributed, for example, the neighboring cell is able to take over 5 more terminal apparatuses, the neighboring cell may preserve frequency band resources and computation resources for 5 terminal apparatuses and respond with the preserved information to the capacity booster cell CBC.

Accordingly, the capacity booster cell CBC and the neighboring cell complete the preparation before handover. Therefore, in operation OP107, the capacity booster cell CBC hands over the communication service of the terminal apparatuses; in the meantime, in operation OP207, the neighboring cell takes over the terminal apparatuses.

Next, in operation OP109, the capacity booster cell CBC confirms whether the communication service of all of the connected terminal apparatuses has been handed over. If the communication service is not able to be handed over due to insufficient base station capacity, handover failure, or other reasons, the capacity booster cell CBC returns to the operation OP105, trying the handover again.

In some embodiments, in order to avoid executing the handovers repeatedly and the neighboring cells are not able to provide capacity in a short time, the capacity booster cell CBC sets a timer and transmits the handover request again after waiting for a period of time (e.g., 10 seconds).

Next, after the communication service of all of the terminal apparatuses has been handed over, in operation OP111, the capacity booster cell CBC switches to the energy saving mode ES.

In some embodiments, after completing handing over the communication service of all of the terminal apparatuses, the capacity booster cell CBC notifies the neighboring cell that it is going to enter into the energy saving mode ES. Correspondingly, in operation OP209, the neighboring cell removes the capacity booster cell CBC from a neighboring cell list after receiving the notification.

Specifically, in response to the capacity booster cell CBC being switched to the energy saving transition mode EST, the processor 12 further executes the following operations: in response to completing handing over the communication service of the at least one terminal apparatus, transmitting a notification signal to the at least one neighboring cell to make the at least one neighboring cell to remove the capacity booster cell CBC from a neighboring cell list; and after completing transmitting the notification signal, switching the capacity booster cell CBC to the energy saving mode ES.

For example, the capacity booster cell CBC notifies the neighboring cells of its preparation to enter into the energy saving mode ES via Xn interface. After receiving the notification, the neighboring cell updates the Automatic Neighbor Relation list (ANR list).

In some embodiments, in order to avoid being unable to hand over the communication service of all of the terminal apparatuses and remaining in the energy saving transition mode EST, thereby causing the capacity booster cell CBC to be unable to switch to the energy saving mode ES and unable to serve new terminal apparatuses, the capacity booster cell CBC also sets certain condition to avoid being trapped in infinite loop.

Specifically, after the capacity booster cell CBC is switched to the energy saving transition mode EST, in response to meeting an escape condition, the processor 12 switches the capacity booster cell CBC to the active mode ACT.

Specifically, the escape condition includes a duration after the capacity booster cell CBC being switched to the energy saving transition mode EST exceeds a time period threshold before the capacity booster cell CBC being switched to the energy saving mode ES.

For example, if the capacity booster cell CBC has switched to the energy saving transition mode EST more than 10 seconds and is unable to be switched to the energy saving mode ES due to its failure to hand over the communication service of all of the terminal apparatuses, the processor 12 switches the capacity booster cell CBC back to the active mode ACT.

Specifically, the escape condition includes the capacity booster cell CBC transmitting the handover request to the neighboring cell more than a times threshold.

For example, when the capacity booster cell CBC tries to transmit the handover request to the neighboring cell more than 5 times and is unable to hand over the communication service of all of the terminal apparatuses and switch to the energy saving mode ES due to excessive neighboring cell load, the processor 12 then switches the capacity booster cell CBC to the active mode ACT.

It is noted that, the escape conditions mentioned in the present disclosure are used for illustration, and the present disclosure is not limited thereto. Practically, the capacity booster cell CBC may set other escape conditions as needed.

Furthermore, in some embodiments, if the capacity booster cell CBC is switched to the active mode ACT due to triggering the escape condition, it may indicates that the capacity booster cell CBC is unable to enter into the energy saving mode ES temporarily. Therefore, after being switched back to the active mode ACT, the capacity booster cell CBC sets a timer to avoid being switched back to the energy saving transition mode EST again in a short time.

Specifically, in response to the escape condition being met, after the capacity booster cell CBC is switched to the active mode ACT, the processor 12 will not switch the capacity booster cell CBC to the energy saving transition mode EST in a specific time period.

For ease of explanation, please refer to FIG. 4C, which is a schematic diagram illustrating the capacity booster cell CBC switching from the active mode ACT to the energy saving mode ES according to another embodiment of the present disclosure, wherein operations OP101, OP103, OP105, OP107, OP109, and OP111 are similar to the corresponding operations shown in FIG. 4A, thus the similarities will not be repeated again.

In the operation OP109, if being unable to hand over the communication service of all of the terminal apparatuses, the capacity booster cell CBC executes an operation OP110, determining whether the escape condition has been met. If the escape condition is met, the capacity booster cell CBC executes an operation OP112; if the escape condition is not met, the capacity booster cell CBC returns to the operation OP105.

Namely, if the capacity booster cell CBC has transmitted too many handover requests and/or has been in the energy saving transition mode EST for too long, the capacity booster cell CBC executes an operation OP112, switching to the active mode ACT.

Furthermore, after switching to the active mode ACT, the capacity booster cell CBC executes an operation OP113, after waiting for a certain period of time, the capacity booster cell CBC then returns to the operation OP101 to determine whether to switch to the energy saving transition mode EST.

According to the aforementioned embodiments, through switching to the energy saving transition mode EST first and then coordinating load and handing over the communication service of the terminal apparatuses with the neighboring cells, the capacity booster cell CBC in the present disclosure is able to ensure that the communication service of all of the terminal apparatuses can be handed over before switching to the energy saving mode ES and avoid being requested by the terminal apparatuses. In the meantime, before switching to the energy saving mode ES, the capacity booster cell CBC ensures that the neighboring cells have sufficient capacity available for accommodating the terminal apparatuses. Additionally, the capacity booster cell CBC can avoid the need to switch back to the active mode ACT due to neighboring cell overload in a short period of time. Furthermore, after switching to the energy saving transition mode EST, the capacity booster cell CBC can also set the escape condition to avoid being unable to switch to the energy saving mode ES and staying in the energy saving transition mode EST.

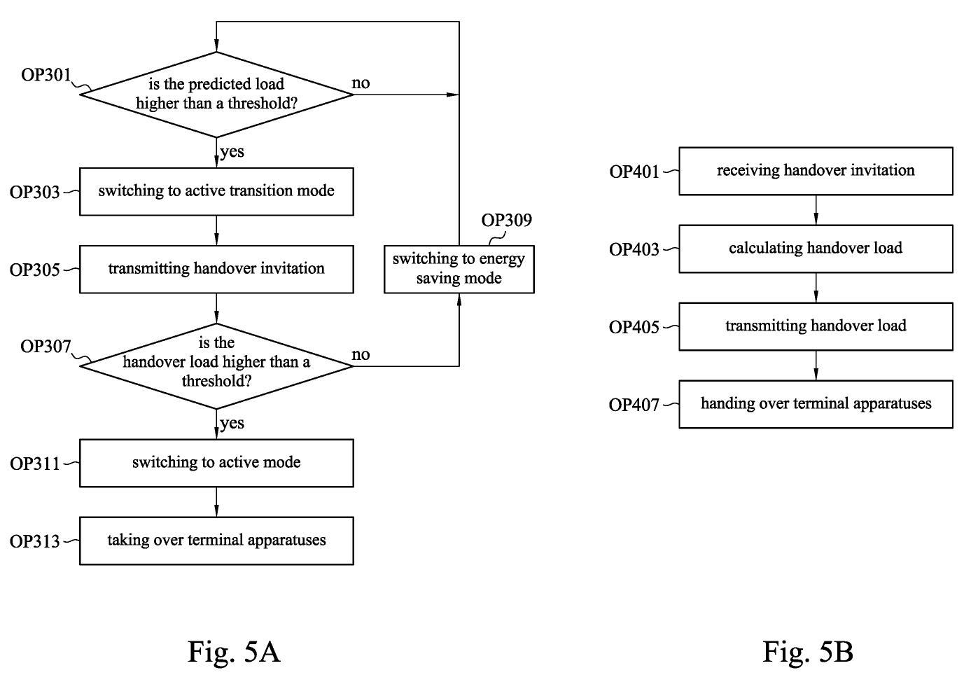

Furthermore, please refer to FIG. 5A, which is a schematic diagram illustrating the capacity booster cell CBC switching from the energy saving mode ES to the active mode ACT according to an embodiment of the present disclosure. On the other hand, please also refer to FIG. 5B, which is a schematic diagram illustrating the coverage cell CC operating corresponding to FIG. 5A according to an embodiment of the present disclosure.

First, in an operation OP301, the capacity booster cell CBC determines whether a predicted load of the coverage cell CC is higher than a threshold.

Similarly, in some embodiments, after being switched to the energy saving mode ES, the capacity booster cell CBC receives load data from the coverage cell CC continuously and calculates the future predicted load by using a machine learning model based on the past and current load data of the coverage cell CC (i.e., the past load record). The load data includes information such as frequency bands being distributed and used, the physical resource blocks (PRB), the number of connected apparatuses, the upstream traffic, the downstream traffic, etc.

Specifically, the operation of determining whether to switch the capacity booster cell CBC to the active transition mode AT further includes: calculating the predicted load information of the coverage cell CC based on a past load record of the coverage cell CC; and in response to the predicted load information being higher than a second load threshold, determining to switch the capacity booster cell CBC to the active transition mode AT.

It is noted that, the machine learning model used for calculating the predicted load is generated after trained and/or fine-tuned by using the past load data based on a model structure such as LSTM, Transformer, GRU, etc., but the present disclosure is not limited thereto.

It is noted that, the second load threshold may be calculated based on the past load record. In some embodiments, the capacity booster cell CBC calculates the average value of multiple load traffic values of the coverage cell CC in the past period of time as the second load threshold.

In some embodiments, the machine learning model calculates the predicted traffic of the coverage cell CC in the future period of time, and the capacity booster cell CBC determines whether the predicted traffic is higher than the second load threshold to decide whether to switch the mode.

If the predicted traffic is not higher than the second load threshold, the capacity booster cell CBC remains in the energy saving mode ES and calculates the predicted traffic continuously; relatively, if the predicted traffic is higher than the second load threshold, the capacity booster cell CBC executes an operation OP303, switching to the active transition mode AT.

In some cases, part of the load carried by the coverage cell CC may not be situated in the signal coverage area and/or the service area of the capacity booster cell CBC. Accordingly, in some embodiments, the capacity booster cell CBC also determines how much traffic can be taken over by the capacity booster cell CBC based on the load data provided from the coverage cell CC and further determines whether to switch to the active transition mode AT based on the load able to be taken over. For example, the capacity booster cell CBC determines how much load able to be taken over based on locations of the terminal apparatuses.

Specifically, the operation of determining whether to switch the capacity booster cell CBC to the active transition mode AT further includes: based on the past load record of the coverage cell CC, calculating a predicted handover load corresponding to the capacity booster cell CBC in the past load record; and in response to the predicted handover load being higher than the second load threshold, then determining to switch the capacity booster cell CBC to the active transition mode AT.

In some embodiments, the capacity booster cell CBC may calculate its predicted traffic by using a machine learning model (e.g., the machine learning model used for calculating the predicted traffic of the capacity booster cell CBC in the aforementioned embodiments) based on the past load data.

In another embodiment, the capacity booster cell CBC also determines which terminal apparatuses are able to be taken over based on the future trajectories of the terminal apparatuses. For example, the capacity booster cell CBC calculates the trajectories by using the machine learning model used for predicting the terminal apparatus trajectories in the aforementioned embodiment.

After switching to the active transition mode AT, in an operation OP305, the capacity booster cell CBC transmits a handover invitation to the coverage cell CC.

For example, the capacity booster cell CBC transmits a resource status update signal to the coverage cell CC, wherein the resource status update signal includes an offload invite signal and the amount of resources that can be accommodated by the capacity booster cell CBC. The amount of resources includes the traffic that can be accommodated, available spectrum, allowable power values and/or maximum capacity of apparatuses.

Please return to FIG. 5B, after the capacity booster cell CBC transmits the handover invitation, in an operation OP401, the coverage cell CC receives the handover invitation.

Furthermore, in an operation OP403, the coverage cell CC calculates the load able to be handed over to the capacity booster cell CBC (e.g., the terminal apparatus number and/or traffic can be handed over) based on the handover invitation.

Next, in an operation OP405, the coverage cell CC transmits a handover request to the capacity booster cell CBC based on the handover load.

In some embodiments, the coverage cell CC calculates the load to be handed over to the capacity booster cell CBC based on the terminal apparatuses in the signal coverage area of the capacity booster cell CBC.

Specifically, the handover request is generated through the following operations: calculating a handover load corresponding to the capacity booster cell CBC based on at least one location information corresponding to at least one surrounding terminal apparatus; and generating the handover request based on the handover load.

In some cases, the capacity booster cell CBC will still broadcast SSB and SIB1 signals while being in the energy saving mode ES. Correspondingly, the terminal apparatuses around the capacity booster cell CBC are able to sense the existence of the capacity booster cell CBC and confirm the distance and/or the relative location to the capacity booster cell CBC.

Accordingly, the coverage cell CC is able to calculate how many terminal apparatuses are in the signal coverage area of the capacity booster cell CBC based on the distance and/or the relative location reported by the terminal apparatuses, so as to calculate the handover load.

In other cases, the capacity booster cell CBC will not broadcast the SSB and SIB1 signals while being in the energy saving mode ES. Correspondingly, the terminal apparatuses around the capacity booster cell CBC are unable to confirm the distance and/or the relative location to the capacity booster cell CBC.

Accordingly, the coverage cell CC predicts whether the future trajectories of the terminal apparatuses will enter the signal coverage area of the capacity booster cell CBC by using a machine learning model (e.g., the machine learning model used for predicting the trajectories of the terminal apparatuses in the aforementioned embodiments) based on the past and current locations of the terminal apparatuses, so as to calculate the handover load.

Specifically, the handover request is generated through the following operations: calculating at least one predicted location of at least one surrounding terminal apparatus based on at least one past load record of the at least one surrounding terminal apparatus; and calculating a handover load corresponding to the capacity booster cell CBC based on the at least one predicted location to generate the handover request.

After calculating the handover load, the coverage cell CC transmits the handover request accordingly, wherein the handover request includes the quantity, traffic, predicted trajectories, service requirements (e.g., frequency band, QoS) of the terminal apparatuses expected to be handed over.

Correspondingly, after receiving the handover request, in order to determine whether it is efficient for the capacity booster cell CBC to switch to the active mode ACT, in an operation OP307, the capacity booster cell CBC determines whether the handover load is higher than a third load threshold.

Specifically, the operation of determining whether to switch the capacity booster cell CBC to the active mode ACT further includes: in response to a handover load in the handover request being higher than a third load threshold, determining to switch the capacity booster cell CBC to the active mode ACT.

If the handover load is not higher than the third load threshold, the capacity booster cell CBC determines that there is no need to switch to the active mode ACT and responds with a cancel handover signal to the coverage cell CC to cancel the handover operation. Next, in an operation OP309, the capacity booster cell CBC switches to the energy saving mode ES and returns to the operation OP301.

If the handover load is higher than the third load threshold, in an operation OP311, the capacity booster cell CBC responds with a handover acknowledgement signal and switches to the active mode ACT. Correspondingly, in an operation OP407, the coverage cell CC starts to hand over the communication service of the terminal apparatuses; in the meantime, in an operation OP313, the capacity booster cell CBC hands over the terminal apparatuses.

It is noted that, in some embodiments, the handover acknowledgement signal includes the number of terminal apparatuses able to be taken over by the capacity booster cell CBC, the preserved frequency band resource, and/or the preserved computation resource.

It is noted that, the third load threshold may be calculated based on the past load record of the capacity booster cell CBC. In some embodiments, similar to the first load threshold, the capacity booster cell CBC calculates the average value of multiple load traffic values of itself in the past period of time as the third load threshold.

According to the aforementioned embodiments, through switching to the active transition mode AT first and then confirming the terminal apparatuses and load expected to be handed over with the coverage cell CC, the capacity booster cell CBC in the present disclosure is able to ensure that it is efficient to switch to the active mode ACT. Additionally, through predicting and monitoring the load of the coverage cell CC, the capacity booster cell CBC is able to share the load timely. In the meantime, the capacity booster cell CBC can determine the handover load precisely through determining whether each of the terminal apparatuses is in the signal coverage area of the capacity booster cell CBC.

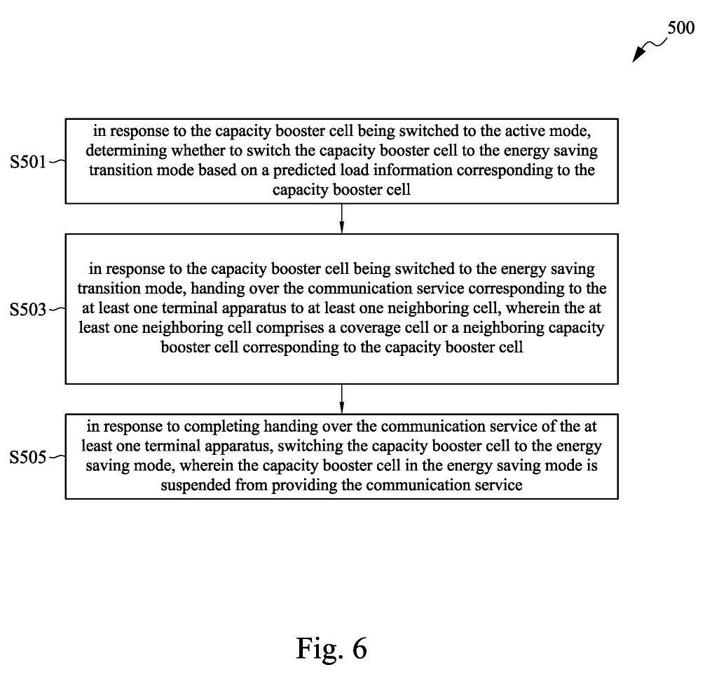

Please refer to FIG. 6, is a flow diagram illustrating a base station control method 500 switching from an active mode ACT to an energy saving mode ES according to another embodiment of the present disclosure. The base station control method 500 includes steps S501-S505. The base station control method 500 is configured to provide a communication service for at least one terminal apparatus via the capacity booster cell CBC based on an active mode ACT, an energy saving transition mode EST, and an energy saving mode ES. The base station control method 500 can be executed by a capacity booster cell CBC (e.g., the capacity booster cell CBC in the first embodiment).

First, in the step S501, the capacity booster cell CBC in response to the capacity booster cell CBC being switched to the active mode ACT, determining whether to switch the capacity booster cell CBC to the energy saving transition mode EST based on a predicted load information corresponding to the capacity booster cell CBC.

Next, in the step S503, the capacity booster cell CBC in response to the capacity booster cell CBC being switched to the energy saving transition mode EST, handing over the communication service corresponding to the at least one terminal apparatus to at least one neighboring cell, wherein the at least one neighboring cell includes a coverage cell CC or a neighboring capacity booster cell CBC corresponding to the capacity booster cell CBC.

Finally, in the step S505, the capacity booster cell CBC in response to completing handing over the communication service of the at least one terminal apparatus, switching the capacity booster cell CBC to the energy saving mode ES, wherein the capacity booster cell CBC in the energy saving mode ES is suspended from providing the communication service.

In some embodiments, the step S501 further includes the capacity booster cell CBC calculating the predicted load information of the capacity booster cell CBC based on a past load record of the capacity booster cell CBC; and in response to the predicted load information being lower than a first load threshold, the capacity booster cell CBC determining to switch the capacity booster cell CBC to the energy saving transition mode EST.

In some embodiments, in response to determining to switch the capacity booster cell CBC to the energy saving transition mode EST, the base station control method 500 further includes the following steps: the capacity booster cell CBC broadcasting a first barring signal to at least one neighboring terminal apparatus to suspend the communication service for the at least one neighboring terminal apparatus; the capacity booster cell CBC transmitting a second barring signal to the at least one neighboring cell to reject a handover request corresponding to the at least one neighboring cell; in response to receiving the handover request from the at least one neighboring cell, the capacity booster cell CBC returning a cancel handover signal to the at least one neighboring cell; and after broadcasting the first barring signal and transmitting the second barring signal, the capacity booster cell CBC switching the capacity booster cell CBC to the energy saving transition mode EST.

In some embodiments, the step S503 further includes: the capacity booster cell CBC distributing the at least one terminal apparatus to the at least one neighboring cell respectively based on at least one trajectory prediction corresponding to the at least one terminal apparatus to generate a distribution result; the capacity booster cell CBC transmitting at least one handover request to the at least one neighboring cell based on the distribution result; the capacity booster cell CBC receiving a handover response corresponding to the at least one handover request from the at least one neighboring cell; and the capacity booster cell CBC handing over the communication service of at least one of the at least one terminal apparatus based on the handover response.

In some embodiments, in response to the capacity booster cell CBC being switched to the energy saving transition mode EST, the base station control method 500 further includes the following steps: in response to completing handing over the communication service of the at least one terminal apparatus, the capacity booster cell CBC transmitting a notification signal to the at least one neighboring cell to make the at least one neighboring cell to remove the capacity booster cell CBC from a neighboring cell list; and after completing transmitting the notification signal, the capacity booster cell CBC switching the capacity booster cell CBC to the energy saving mode ES.

In some embodiments, in response to the capacity booster cell CBC being switched to the energy saving transition mode EST, the base station control method 500 further includes the following steps: the capacity booster cell CBC obtaining at least one neighboring load information from at least one neighboring cell; and the capacity booster cell CBC determining whether to cancel switching to the energy saving transition mode EST based on the at least one neighboring load information.

In some embodiments, the base station control method 500 further includes the following steps: after the capacity booster cell CBC being switched to the energy saving transition mode EST, in response to meeting an escape condition, the capacity booster cell CBC switching the capacity booster cell CBC to the active mode ACT.

In some embodiments, the escape condition includes a duration after the capacity booster cell CBC being switched to the energy saving transition mode EST exceeds a time period threshold before the capacity booster cell CBC being switched to the energy saving mode ES.

In some embodiments, the escape condition includes the capacity booster cell CBC transmitting the handover request to the neighboring cell more than a times threshold.

In some embodiments, the base station control method 500 further includes the following steps: in response to the escape condition being met, after the capacity booster cell CBC being switched to the active mode ACT, not switching the capacity booster cell CBC to the energy saving transition mode EST in a specific time period.

According to the aforementioned embodiments, through switching the capacity booster cell CBC to the energy saving transition mode EST first and then coordinating load and handing over the communication service of the terminal apparatuses with the neighboring cells, the base station control method 500 in the present disclosure is able to ensure that the capacity booster cell CBC can hand over the communication service of all of the terminal apparatuses before switching to the energy saving mode ES and avoid being requested by the terminal apparatuses. In the meantime, before switching to the energy saving mode ES, the base station control method 500 ensures that the neighboring cells have sufficient capacity available for accommodating the terminal apparatuses. Additionally, the base station control method 500 can avoid the need to switch back to the active mode ACT due to neighboring cell overload in a short period of time. Furthermore, after switching to the energy saving transition mode EST, the base station control method 500 can also set the escape condition to avoid being unable to switch to the energy saving mode ES and staying in the energy saving transition mode EST.

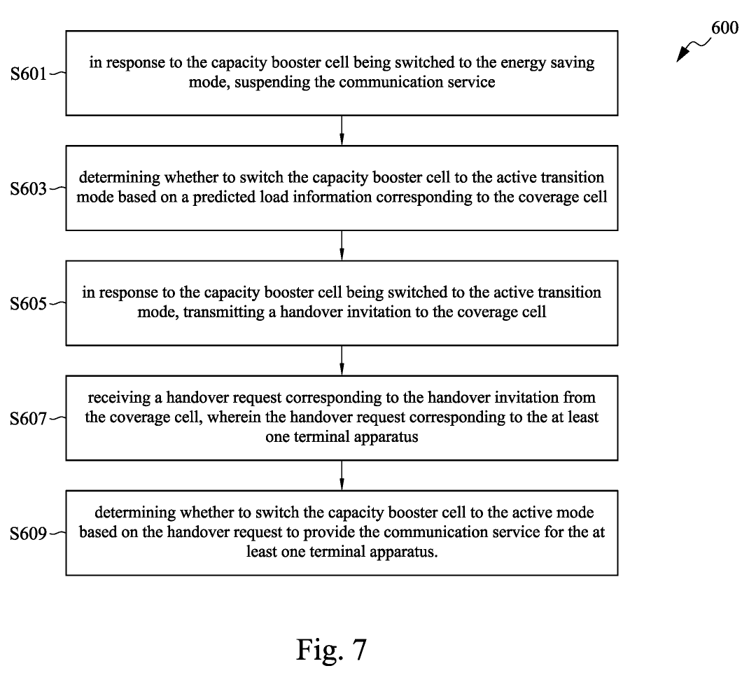

Please refer to FIG. 7, is a flow diagram illustrating a base station control method 600 switching from an energy saving mode ES to an active mode ACT according to another embodiment of the present disclosure. The base station control method 600 includes steps S601-S609. The base station control method 600 is configured to provide a communication service for at least one terminal apparatus via the capacity booster cell CBC based on an energy saving mode ES, an active transition mode AT, and an active mode ACT. The base station control method 600 can be executed by a capacity booster cell CBC (e.g., the capacity booster cell CBC in the first embodiment).

First, in the step S601, in response to being switched to the energy saving mode ES, the capacity booster cell CBC suspends the communication service.

Next, in the step S603, the capacity booster cell CBC determines whether to switch the capacity booster cell CBC to the active transition mode AT based on a predicted load information corresponding to a coverage cell CC.

Next, in the step S605, in response to being switched to the active transition mode AT, the capacity booster cell CBC transmits a handover invitation to the coverage cell CC.

Next, in the step S607, the capacity booster cell CBC receives a handover request corresponding to the handover invitation from the coverage cell CC, wherein the handover request corresponding to the at least one terminal apparatus.

Finally, in the step S609, the capacity booster cell CBC determines whether to switch the capacity booster cell CBC to the active mode ACT based on the handover request to provide the communication service for the at least one terminal apparatus.

In some embodiments, the step S603 further includes: the capacity booster cell CBC calculating the predicted load information of the coverage cell CC based on a past load record of the coverage cell CC; and in response to the predicted load information being higher than a second load threshold, the capacity booster cell CBC determining to switch the capacity booster cell CBC to the active transition mode AT.

In some embodiments, the handover request is generated through the following steps: calculating a handover load corresponding to the capacity booster cell CBC based on at least one location information corresponding to at least one surrounding terminal apparatus; and generating the handover request based on the handover load.

In some embodiments, the handover request is generated through the following steps: calculating at least one predicted location of at least one surrounding terminal apparatus based on at least one past load record of the at least one surrounding terminal apparatus; and calculating a handover load corresponding to the capacity booster cell CBC based on the at least one predicted location to generate the handover request.

In some embodiments, the step S609 further includes: in response to a handover load in the handover request being higher than a third load threshold, the capacity booster cell CBC determining to switch the capacity booster cell CBC to the active mode ACT.

In some embodiments, the step S603 further includes: based on the past load record of the coverage cell CC, the capacity booster cell CBC calculating a predicted handover load corresponding to the capacity booster cell CBC in the past load record; and in response to the predicted handover load being higher than the second load threshold, the capacity booster cell CBC then determining to switch the capacity booster cell CBC to the active transition mode AT.

According to the aforementioned embodiments, through switching the capacity booster cell CBC to the active transition mode AT first and then confirming the terminal apparatuses and load expected to be handed over with the coverage cell CC, the base station control method 600 in the present disclosure is able to ensure that it is efficient to switch to the active mode ACT. Additionally, through predicting and monitoring the load of the coverage cell CC, the base station control method 600 is able to share the load timely. In the meantime, the base station control method 600 can determine the handover load precisely through determining whether each of the terminal apparatuses is in the signal coverage area of the capacity booster cell CBC.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A capacity booster cell, comprising:
a communication interface, communicatively connected to a coverage cell; and
a processor, electrically connected to the communication interface;
wherein the capacity booster cell provides a communication service for at least one terminal apparatus via the communication interface based on an active mode, an energy saving transition mode, and an energy saving mode;
in response to the capacity booster cell being switched to the active mode, the processor executing the following operation:
determining whether to switch the capacity booster cell to the energy saving transition mode based on a predicted load information corresponding to the capacity booster cell;
in response to the capacity booster cell being switched to the energy saving transition mode, the processor executing the following operations:
handing over the communication service corresponding to the at least one terminal apparatus to at least one neighboring cell, wherein the at least one neighboring cell comprises the coverage cell or a neighboring capacity booster cell corresponding to the capacity booster cell; and
in response to completing handing over the communication service of the at least one terminal apparatus, switching the capacity booster cell to the energy saving mode, wherein the capacity booster cell in the energy saving mode is suspended from providing the communication service.

2. The capacity booster cell of claim 1, wherein the operation of determining whether to switch the capacity booster cell to the energy saving transition mode further comprises:
calculating the predicted load information of the capacity booster cell based on a past load record of the capacity booster cell; and
in response to the predicted load information being lower than a first load threshold, determining to switch the capacity booster cell to the energy saving transition mode.

3. The capacity booster cell of claim 1, wherein in response to determining to switch the capacity booster cell to the energy saving transition mode, the processor executes the following operations:
broadcasting a first barring signal to at least one neighboring terminal apparatus to suspend the communication service for the at least one neighboring terminal apparatus;
transmitting a second barring signal to the at least one neighboring cell to reject a handover request corresponding to the at least one neighboring cell;
in response to receiving the handover request from the at least one neighboring cell, returning a cancel handover signal to the at least one neighboring cell; and
after broadcasting the first barring signal and transmitting the second barring signal, switching the capacity booster cell to the energy saving transition mode.

4. The capacity booster cell of claim 1, wherein the operation of handing over the communication service corresponding to the at least one terminal apparatus further comprises:
distributing the at least one terminal apparatus to the at least one neighboring cell respectively based on at least one trajectory prediction corresponding to the at least one terminal apparatus to generate a distribution result;
transmitting at least one handover request to the at least one neighboring cell based on the distribution result;
receiving a handover response corresponding to the at least one handover request from the at least one neighboring cell; and
handing over the communication service of at least one of the at least one terminal apparatus based on the handover response.

5. The capacity booster cell of claim 1, wherein in response to the capacity booster cell being switched to the energy saving transition mode, the processor further executes the following operations:
in response to completing handing over the communication service of the at least one terminal apparatus, transmitting a notification signal to the at least one neighboring cell to make the at least one neighboring cell to remove the capacity booster cell from a neighboring cell list; and
after completing transmitting the notification signal, switching the capacity booster cell to the energy saving mode.

6. A capacity booster cell, comprising:
a communication interface, communicatively connected to a coverage cell; and
a processor, electrically connected to the communication interface;
wherein the capacity booster cell provides a communication service for at least one terminal apparatus via the communication interface based on an energy saving mode, an active transition mode, and an active mode;
in response to the capacity booster cell being switched to the energy saving mode, the processor executing the following operations:
suspending the communication service; and
determining whether to switch the capacity booster cell to the active transition mode based on a predicted load information corresponding to the coverage cell;
in response to the capacity booster cell being switched to the active transition mode, the processor executing the following operations:
transmitting a handover invitation to the coverage cell;
receiving a handover request corresponding to the handover invitation from the coverage cell, wherein the handover request corresponding to the at least one terminal apparatus; and
determining whether to switch the capacity booster cell to the active mode based on the handover request to provide the communication service for the at least one terminal apparatus.

7. The capacity booster cell of claim 6, wherein the operation of determining whether to switch the capacity booster cell to the active transition mode further comprises:
calculating the predicted load information of the coverage cell based on a past load record of the coverage cell; and
in response to the predicted load information being higher than a second load threshold, determining to switch the capacity booster cell to the active transition mode.

8. The capacity booster cell of claim 6, wherein the handover request is generated through the following operations:
calculating a handover load corresponding to the capacity booster cell based on at least one location information corresponding to at least one surrounding terminal apparatus; and
generating the handover request based on the handover load.

9. The capacity booster cell of claim 6, wherein the handover request is generated through the following operations:
calculating at least one predicted location of at least one surrounding terminal apparatus based on at least one past load record of the at least one surrounding terminal apparatus; and
calculating a handover load corresponding to the capacity booster cell based on the at least one predicted location to generate the handover request.

10. The capacity booster cell of claim 6, wherein the operation of determining whether to switch the capacity booster cell to the active mode further comprises:
in response to a handover load in the handover request being higher than a third load threshold, determining to switch the capacity booster cell to the active mode.

11. A control method, being adapted for use in a capacity booster cell, wherein:
the control method provides a communication service for at least one terminal apparatus via the capacity booster cell based on an active mode, an energy saving transition mode, and an energy saving mode;
in response to the capacity booster cell being switched to the active mode, the control method comprises the following step:
determining whether to switch the capacity booster cell to the energy saving transition mode based on a predicted load information corresponding to the capacity booster cell;
in response to the capacity booster cell being switched to the energy saving transition mode, the control method comprises the following steps:
handing over the communication service corresponding to the at least one terminal apparatus to at least one neighboring cell, wherein the at least one neighboring cell comprises a coverage cell or a neighboring capacity booster cell corresponding to the capacity booster cell; and
in response to completing handing over the communication service of the at least one terminal apparatus, switching the capacity booster cell to the energy saving mode, wherein the capacity booster cell in the energy saving mode is suspended from providing the communication service.

12. The control method of claim 11, wherein the step of determining whether to switch the capacity booster cell to the energy saving transition mode further comprises:
calculating the predicted load information of the capacity booster cell based on a past load record of the capacity booster cell; and
in response to the predicted load information being lower than a first load threshold, determining to switch the capacity booster cell to the energy saving transition mode.

13. The control method of claim 11, wherein in response to determining to switch the capacity booster cell to the energy saving transition mode, the control method further comprises the following steps:
broadcasting a first barring signal to at least one neighboring terminal apparatus to suspend the communication service for the at least one neighboring terminal apparatus;
transmitting a second barring signal to the at least one neighboring cell to reject a handover request corresponding to the at least one neighboring cell;
in response to receiving the handover request from the at least one neighboring cell, returning a cancel handover signal to the at least one neighboring cell; and
after broadcasting the first barring signal and transmitting the second barring signal, switching the capacity booster cell to the energy saving transition mode.

14. The control method of claim 11, wherein the step of handing over the communication service corresponding to the at least one terminal apparatus further comprises:
distributing the at least one terminal apparatus to the at least one neighboring cell respectively based on at least one trajectory prediction corresponding to the at least one terminal apparatus to generate a distribution result;
transmitting at least one handover request to the at least one neighboring cell based on the distribution result;
receiving a handover response corresponding to the at least one handover request from the at least one neighboring cell; and
handing over the communication service of at least one of the at least one terminal apparatus based on the handover response.

15. The control method of claim 11, wherein in response to the capacity booster cell being switched to the energy saving transition mode, the control method further comprises the following steps:
in response to completing handing over the communication service of the at least one terminal apparatus, transmitting a notification signal to the at least one neighboring cell to make the at least one neighboring cell to remove the capacity booster cell from a neighboring cell list; and
after completing transmitting the notification signal, switching the capacity booster cell to the energy saving mode.

16. A control method, being adapted for use in a capacity booster cell, wherein:
the control method provides a communication service for at least one terminal apparatus via the capacity booster cell based on an energy saving mode, an active transition mode, and an active mode;
in response to the capacity booster cell being switched to the energy saving mode, the control method comprises the following steps:
suspending the communication service; and
determining whether to switch the capacity booster cell to the active transition mode based on a predicted load information corresponding to a coverage cell;
in response to the capacity booster cell being switched to the active transition mode, the control method comprises the following steps:
transmitting a handover invitation to the coverage cell;
receiving a handover request corresponding to the handover invitation from the coverage cell, wherein the handover request corresponding to the at least one terminal apparatus; and
determining whether to switch the capacity booster cell to the active mode based on the handover request to provide the communication service for the at least one terminal apparatus.

17. The control method of claim 16, wherein the step of determining whether to switch the capacity booster cell to the active transition mode further comprises:
calculating the predicted load information of the coverage cell based on a past load record of the coverage cell; and
in response to the predicted load information being higher than a second load threshold, determining to switch the capacity booster cell to the active transition mode.

18. The control method of claim 16, wherein the handover request is generated through the following steps:
calculating a handover load corresponding to the capacity booster cell based on at least one location information corresponding to at least one surrounding terminal apparatus; and
generating the handover request based on the handover load.

19. The control method of claim 16, wherein the handover request is generated through the following steps:
calculating at least one predicted location of at least one surrounding terminal apparatus based on at least one past load record of the at least one surrounding terminal apparatus; and
calculating a handover load corresponding to the capacity booster cell based on the at least one predicted location to generate the handover request.

20. The control method of claim 16, wherein the step of determining whether to switch the capacity booster cell to the active mode further comprises:
in response to a handover load in the handover request being higher than a third load threshold, determining to switch the capacity booster cell to the active mode.
